(19) United States
(12) Patent Application Publication
(10) Pub. No.: US 2021/0267287 A1
(43) Pub. Date: Sep. 2, 2021

(54) STRIP-SHAPED ELASTIC MEMBER AND MASK USING THE SAME

(71) Applicant: HOSEN CHEN ENTERPRISE CO., LTD., Lukang Township (TW)

(72) Inventor: A-NAN CHEN, Lukang Township (TW)

(73) Assignee: HOSEN CHEN ENTERPRISE CO., LTD., Lukang Township (TW)

(21) Appl. No.: 16/901,604

(22) Filed: Jun. 15, 2020

(30) Foreign Application Priority Data
Feb. 27, 2020 (TW) 109202261

(51) Int. Cl. A41D 13/11

(52) U.S. Cl. CPC A41D 13/1161; A41D 13/1115

(57) ABSTRACT

A strip-shaped elastic member, which is adapted for being formed into an ear loop of a mask, includes a first end, a second end opposite to the first end, and a stretchable portion located between the first end and the second end and having a wave structure. When the strip-shaped elastic member is formed into the ear loop of the mask, the wave structure is adapted for contacting the ear of the user wearing the mask, thereby providing comfortable wearing experience to the user. Besides, resulted from the stretchable portion having the wave structure, the strip-shaped elastic member has a relatively larger stretchable length. A mask including a mask body and two ear loops formed from the aforesaid strip-shaped elastic members is disclosed too.

### BACKGROUND OF THE INVENTION

### 1. Field of the Invention

The present invention relates to masks and more particularly, to a strip-shaped elastic member adapted for being made into an ear loop of a mask. The present invention also relates to a mask using the aforementioned strip-shaped elastic member.

### 2. Description of the Related Art

A conventional mask 10, such as a mask disclosed by Taiwan Utility Model Patent No. M568150, is shown in FIG. 1. The mask 10 basically consists of a mask body 11 and two ear loops 13. FIG. 1 only shows the right half of the mask, so only one ear loop 13 is shown. In order to fit different facial contours of users, the ear loops 13 are often made of stretchable strip-shaped elastic members, such as elastic ropes, elastic bands and so on. When the user wears the mask, the elastic members are stretched and tensioned so that their contact sections are entirely attached to the ears of the user. After the user wears the mask for a long time, the ears often have impressions and the skins thereon are even inflamed or injured because of long-term stress applied thereto, making the user feel uncomfortable. Secondly, although the conventional elastic member, such as elastic rope, is made of elastic yarn and thereby stretchable, the whole structure thereof is shaped as a straight line, therefore the stretchable length thereof is so limited as to be fitted for only a specific range of users. Thus, in order to fit various facial contours and sizes of users as much as possible, the commercially available masks provided by the manufacturer often have long elastic members for enabling the user to adjust the length of the elastic members by himself/herself. This solution not only causes inconvenience to the user but also increases manufacturing cost. Besides, when the afore-described conventional straight-line-shaped elastic member is stretched, the tension of the elastic member becomes larger and the diameter of the elastic member becomes smaller, resulting in more discomfort to the wearer. In other words, the conventional strip-shaped elastic member for being made into the ear loop of the mask still needs improvement.

### SUMMARY OF THE INVENTION

The present invention has been accomplished in view of the above-noted circumstances. It is an objective of the present invention to provide a strip-shaped elastic member for being formed into an ear loop of a mask, which can resolve at least one of the above-described problems in the description of the related art.

To attain the above objective, the present invention provides a strip-shaped elastic member which is adapted for being formed into an ear loop of a mask. The strip-shaped elastic member includes a first end, a second end, and a stretchable portion located between the first and second ends and having a wave structure.

As a result, because the stretchable portion of the strip-shaped elastic member has the wave structure, even if the strip-shaped elastic member, which has been formed into the ear loop of the mask, is stretched to a certain length, it is the wave structure, not a completely stretched and tensioned surface, contacting the ear of the user, so the user may feel relatively more comfortable when wearing the mask. Secondly, resulted from the stretchable portion having the wave structure, the stretchable length of the strip-shaped elastic member of the present invention is larger than the stretchable length of the conventional straight-line-shaped elastic member, resulting in that the mask having the ear loop formed from the strip-shaped elastic member of the present invention may fit wearers of different facial contours and sizes.

In a preferred embodiment of the present invention, the stretchable portion may be distributed in at least a certain part between the first and second ends. Preferably, the stretchable portion extends completely from the first end to the second end for attaining the largest stretchable length.

Preferably, the wave structure of the stretchable portion has a plurality of pleated sections connected integrally, and each of the pleated sections has a first wave segment protruding toward a first direction, and a second wave segment integrally connected with the first wave segment and protruding toward a second direction differing from the first direction. In this way, the strip-shaped elastic member may contact the ear of the user by the pleated sections, not by a completely stretched and tensioned contact segment, so that the user may feel relatively more comfortable when wearing the mask.

Preferably, the first wave segment of each of the pleated sections has a wave crest, the second wave segment of each of the pleated sections has a wave trough, and a stretch space exists between the wave crests of two adjacent pleated sections. In this way, a relatively larger stretchable extent and air permeable effect are provided to bring wearing comfort.

Preferably, the strip-shaped elastic member is composed of a plurality of strands of yarn intertwined with each other, and the elastic recovery rate of at least one strand of yarn of the plurality of strands of yarn is higher than the elastic recovery rate of the other strand of yarn, so that the stretchable portion having the wave structure is formed. Besides, by the adjustment of the amount of the strands of yarn with the relatively higher elastic recovery rate, the elastic recovery rate of the whole strip-shaped elastic member and the pre-compressedly abutted extent of the pleated sections are adjustable.

It is another objective of the present invention to provide a mask using the above-described strip-shaped elastic member, which can provide wearing comfort to the wearer and can fit various facial contours and sizes of wearers.

To attain the above objective, the present invention provides a mask which includes a mask body and two ear loops fixed to first and second sides of the mask body respectively, and each of the ear loops is formed from the above-described strip-shaped elastic member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic front view showing a part of a conventional mask.

FIG. 2 is a schematic front view of a mask according to an embodiment of the present invention.

FIG. 3 is a schematic view of a strip-shaped elastic member according to the embodiment of the present invention, showing the state that the strip-shaped elastic member is not stretched.

FIG. 4 is a schematic view of the strip-shaped elastic member according to the embodiment of the present invention, showing the state that the strip-shaped elastic member is stretched.

FIG. 5 is a schematic view showing that the strip-shaped elastic member according to the embodiment of the present invention consists of a plurality of strands of yarn intertwined with each other.

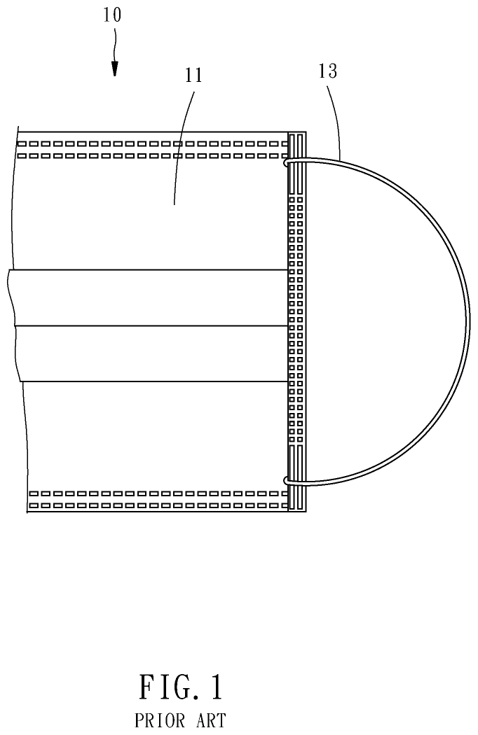

### DETAILED DESCRIPTION OF THE INVENTION

First of all, it is to be mentioned that same reference numerals used in the following embodiment and the appendix drawings designate same or similar elements or the structural features thereof.

Secondly, in the description of the present invention, it should be understood that the directional or positional relationship indicated by the terms ‘center’, ‘up’, ‘down’, ‘front’, ‘rear’, ‘left’, ‘right’, ‘vertical’, ‘horizontal’, ‘top’, ‘bottom’, ‘in’, ‘out’ and so on is based on the directional or positional relationship shown in the drawings, only for the convenience of describing the present invention and simplifying the description, not indicating or implying that the associated device or element must have a specific orientation or be constructed and operated in a specific orientation, and therefore shouldn't be considered as a limitation of the present invention.

Besides, the appendix drawings of the present invention are drawn to facilitate the description of the technical features of the present invention, and the dimensional scale and relationship between the elements disclosed therein are not necessarily drawn according to the actual product, so it cannot be considered as a limitation of the present invention.

In addition, in the description of the present invention, it should be noted that unless there is additional definite regulation and limitation, the terms ‘install’, ‘connect’ and ‘dispose’ should be broadly interpreted. For example, the terms ‘connect’ and ‘dispose’ may mean ‘fixedly connect’ and ‘fixedly dispose’, or may mean ‘detachably connect’ and ‘detachably dispose’, or ‘integrally connect’ and ‘integrally dispose’. For those having ordinary skill in the art, the specific meaning of the abovementioned terms in the present invention is understandable according to specific situations.

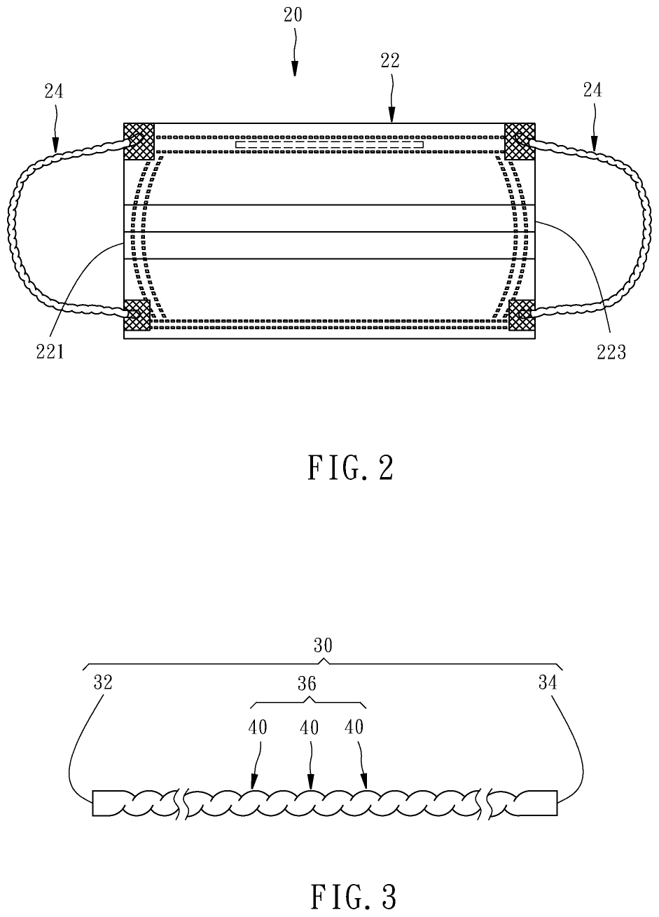

Referring to FIG. 2, a mask 20 according to an embodiment of the present invention is illustratively shown. The mask 20 is basically composed of a mask body 22 and two ear loops 24. The mask body 22 suitable for being used in the mask 20 of the present invention may, but unlimited to, be medical-grade or non-medical-grade products made of single-layer or multi-layer fabrics, melt-blown nonwoven, or activated carbon contained material. The mask body 22 has a first side 221, namely the left side as shown in FIG. 2, and a second side 223, namely the right side as shown in FIG. 2, opposite to the first side 221. The two ear loops 24 are fixed to the first side 221 and the second side 223 of the mask body 22, respectively, for being worn and hanged on both ears of the user. The primary technical feature of the present invention lies in that each of the ear loops 24 is formed from a strip-shaped elastic member 30 as shown in FIG. 3.

It should be noted that the term ‘stripe-shaped elastic member’ mentioned in the present invention refers to an elongated strip-shaped element, such as wire, rope, belt or band, which can be stretched to change its length when a general mask user applies a force by the hand thereof to pull it. In the embodiment disclosed in the figures of the present invention, it is realized in the form of an elongated strip-shaped elastic rope, but the present invention is unlimited thereto.

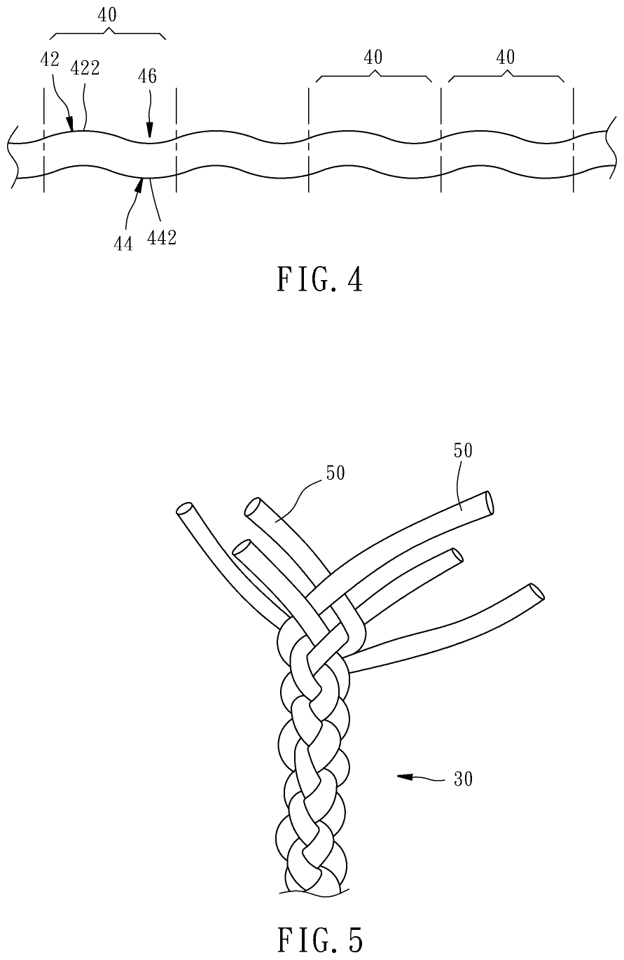

Specifically speaking, the strip-shaped elastic member 30 according to the embodiment of the present invention is illustratively shown in FIG. 3, showing the state that the strip-shaped elastic member 30 is not stretched. FIG. 4 shows the state that the strip-shaped elastic member 30 is stretched. Referring to FIG. 3, the strip-shaped elastic member 30 has a first end 32, a second end 34 opposite to the first end 32 and a stretchable portion 36 located between the first end 32 and the second end 34 and having a wave structure. The first end 32 is fixed to the first side 221 or the second side 223 of the mask body 22, such as the position at the top end of the first side 221. The second end 34 is fixed to the mask body 22 and located on the same side with the first end 32, such as the position at the bottom end of the first side 221. In this way, the trip-shaped elastic member 30 can be formed into an ear loop 24. It should be noted that the first end 32 and the second end 34 may, but unlimited to, be fixed to the mask body 22 by any suitable fastening way, such as thermal compressing, ultrasonic welding, inserting and tying, and so on. In other words, the fastening way is not specifically limited. Secondly, in this embodiment, the stretchable portion 36 extends completely from the first end 32 to the second end 34. However, in practice, the stretchable portion 36 may be only distributed in a specific part between the first and second ends 32 and 34, such as the middle part. Alternatively, there may be a plurality of stretchable portions 36 having the wave structure and separately located in some specific parts, such as the left terminal part, the middle part and the right terminal part. However, in order to provide the trip-shaped elastic member 30 with the largest stretchable length under the same unit length, it is preferably that the stretchable portion 36 is configured extending completely from the first end 32 to the second end 34. That is, as shown in FIG. 3, the stretchable portion 36 is continuously provided from the first end 32 to the second end 34 for attaining the largest stretchable length.

Referring to FIG. 3 and FIG. 4, in the strip-shaped elastic member 30 provided by the present invention, the wave structure of the stretchable portion 36 has a plurality of pleated sections 40 connected integrally. The pleated sections 40 are shown in FIG. 4 as the sections defined by imaginary lines. Each of the pleated sections 40 has a first wave segment 42 protruding toward a first direction, such as the straight upward direction in FIG. 4, and a second wave segment 44 integrally connected with the first wave segment 42 and protruding toward a second direction differing from the first direction, such as the straight downward direction in FIG. 4. The first wave segment 42 of each of the pleated sections 40 has a wave crest 422. In contrast, the second wave segment 44 of each of the pleated sections 40 has a wave trough 442. A stretch space 46 exists between the wave crests 422 of two adjacent pleated sections 40. On the other hand, the wave troughs 442 of two adjacent pleated sections 40 also have a stretch space existing therebetween.

Referring to FIG. 5, the strip-shaped elastic member 30 provided by the present invention is practically manufactured in a way that a plurality of strands of yarn 50 are intertwined with each other by a textile machine to become the strip-shaped elastic member 30. The manner of intertwining the yarn 50 is not specifically limited, and the amount of yarn may, but unlimited to, be 4 to 24 strands. Each strand of yarn 50 may be elastic yarn made of rubber fibers for example, and have a certain stretchable extent. Besides, in the plurality of strands of yarn 50, the elastic recovery rate of at least one strand (or 2 to 4 strands) of yarn 50 is higher than the elastic recovery rate of the other strands of yarn 50. During the machining process, the yarn 50 with the relatively higher elastic recovery rate is pre-drawn to adjust its tension. After the machining process of intertwining the strands of yarn 50 with each other is accomplished, the yarn 50 with the relatively higher elastic recovery rate returns to its original length, so that the stretchable portion 36 having the wave structure composed of a plurality of pleated sections 40 closely abutted with each other is formed, as shown in FIG. 3. It needs to be explained that the so-called ‘elastic recovery rate’ mentioned in the present invention is defined as the percentage ratio of the shrinkage length to the elongated length, in which the elongated length is the difference of the length of the yarn (hereinafter referred to “length under load”) that the yarn has been stretched and deformed but not broken by a load and the original length of the yarn without having been stretched by the load, and the shrinkage length is the difference of the length under load and the length of the yarn after the load is released. Secondly, the number of strands of yarn with the relatively higher elastic recovery rate is not specifically limited. Besides, by the adjustment of the amount of the strands of yarn with the relatively higher elastic recovery rate, the elastic recovery rate of the whole strip-shaped elastic member 30 and the pre-compressedly abutted extent of the pleated sections 40 are adjustable. In other words, the tightness and overall stretchable length of the ear look 24 are adjustable.

As shown in FIG. 4, when the strip-shaped elastic member 30 is stretched, e.g. when it is made into the ear loop 24 of the mask 20 and stretched to be worn on the ear of the user, the stretchable portion 36 of the strip-shaped elastic member 30, which has the wave structure composed of pleated sections 40, is not tightly attached to the ear of the user by an entire surface, so the user feels relatively more comfortable when wearing the mask. Specifically speaking, the present invention has the technical features that the wave structure of the strip-shaped elastic member 30 has a three-dimensional configuration, and the direction in which the first wave segment 42 of each pleated section 40 protrudes, i.e. the abovementioned first direction, and the direction in which the second wave segment 44 protrudes, i.e. the abovementioned second direction, are different and not fixed. This means the aforementioned first and second directions are not necessarily the straight upward direction or straight downward direction as shown in FIG. 4, but extend toward different directions three-dimensionally. Therefore, when the strip-shaped elastic member 30 is made into the ear loop 24 of the mask 20 and worn on the ear of the user, it contacts the ear of the user mostly by the wave crests 422 and wave troughs 442 of the pleated sections 40. The parts where the stretch space 46 between the wave crests 422 or the stretch space between the wave troughs 442 exist are not in contact with the ear of the user, thereby providing air permeable structure. In other words, the strip-shaped elastic member 30 is not tightly attached to the ear of the user by an entire surface in a completely linearly stretched and tensioned manner, so the user feels relatively more comfortable when wearing the mask. Secondly, because the stretchable portion 36 of the strip-shaped elastic member 30 has the wave structure, the stretchable portion 36 can be at least stretched to the extent that the wave structure is almost linear, but is still not attached to the ear of the user by an entire surface. Therefore, the stretchable length of the strip-shaped elastic member of the present invention is larger than the stretchable length of the conventional straight-line-shaped elastic member, such that the mask 20 equipped with the ear loop 24 can fit wearers of different facial contours and sizes.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A strip-shaped elastic member adapted for being formed into an ear loop of a mask, the strip-shaped elastic member comprising:
a first end;
a second end opposite to the first end; and
a stretchable portion located between the first end and the second end and having a wave structure.

2. The strip-shaped elastic member as claimed in claim 1, wherein the stretchable portion extends from the first end to the second end.

3. The strip-shaped elastic member as claimed in claim 1, wherein the wave structure of the stretchable portion has a plurality of pleated sections connected integrally; each of the pleated sections has a first wave segment protruding toward a first direction, and a second wave segment integrally connected with the first wave segment and protruding toward a second direction differing from the first direction.

4. The strip-shaped elastic member as claimed in claim 3, wherein the first wave segment of each of the pleated sections has a wave crest; the second wave segment of each of the pleated sections has a wave trough; a stretch space exists between the wave crests of two adjacent said pleated sections.

5. The strip-shaped elastic member as claimed in claim 1, wherein the strip-shaped elastic member is composed of a plurality of strands of yarn intertwined with each other; an elastic recovery rate of at least one of the plurality of strands of yarn is higher than an elastic recovery rate of the other one of the plurality of strands of yarn.

6. A mask comprising:
a mask body having a first side and a second side opposite to the first side; and
two ear loops fixed to the first side and the second side of the mask body respectively, each of the ear loops being formed from a strip-shaped elastic member, the strip-shaped elastic member comprising:
a first end fixed to one of the first side and the second side of the mask body;
a second end fixed to the mask body and located on the same side of the mask body with the first end; and
a stretchable portion located between the first end and the second end and having a wave structure.

7. The mask as claimed in claim 6, wherein the stretchable portion extends from the first end to the second end.

8. The mask as claimed in claim 6, wherein the wave structure of the stretchable portion has a plurality of pleated sections connected integrally; each of the pleated sections has a first wave segment protruding toward a first direction and a second wave segment integrally connected with the first wave segment and protruding toward a second direction differing from the first direction.

9. The mask as claimed in claim 8, wherein the first wave segment of each of the pleated sections has a wave crest; the second wave segment of each of the pleated sections has a wave trough; a stretch space exists between the wave crests of two adjacent said pleated sections.

10. The mask as claimed in claim 6, wherein the strip-shaped elastic member is composed of a plurality of strands of yarn intertwined with each other; an elastic recovery rate of at least one of the plurality of strands of yarn is higher than an elastic recovery rate of the other one of the plurality of strands of yarn.
